(19) United States
(12) Patent Application Publication
(10) Pub. No.: US 2026/0249197 A1
(43) Pub. Date: Aug. 27, 2026

(54) TRANSFORMATION OF IN-GAME RESOURCES INTO ON-CHAIN RESOURCES

(71) Applicant: Games2Coins, Austin, TX (US)

(72) Inventors: Manning Reynolds Field, Austin, TX (US); Tawsif Khan, Austin, TX (US); Beau L. Button, Austin, TX (US)

(21) Appl. No.: 19/061,206

(22) Filed: Feb. 24, 2025

(51) Int. Cl. A63F 13/79; A63F 13/73

(52) U.S. Cl. CPC A63F 13/79; A63F 13/73

(57) ABSTRACT

Systems, methods, and computer-readable media are disclosed herein for providing an integrated connectivity platform for transforming in-game resources into on-chain resources. A connectivity platform receives a first transformation request to transform one or more in-game resources into one or more on-chain resources. The connectivity platform detects that a first amount of a real-world resource has been added to an electronic repository associated with the connectivity platform. The connectivity platform increases a resource allocation count associated with the user based on the first amount of the real-world resource. The connectivity platform generates, based on the resource allocation count, a second transformation request to transform a second amount of the real-world resource from the electronic repository into a corresponding set of on-chain resources and transmit this request to a transformation platform.

### SUMMARY

Many video games include in-game virtual resources that may be converted into other in-game resources (e.g., objects within the game, such as playable characters, items, and cosmetic tokens) and vice versa within a closed-loop ecosystem. A closed-loop ecosystem means that, while in-game resources may be converted into one another, these resources cannot generally be converted into any resources outside of the game ecosystem itself. For that reason, any value added into a video game with a closed-loop ecosystem remains within the game indefinitely unless it is removed by the game developers.

In recent years, there has been increasing interest in video games that, instead, operate with an open ecosystem where players themselves may transform in-game resources of value into other resources having value outside of the game. However, existing technologies for transforming in-game resources into other resources typically offer limited flexibility. These technologies are typically limited to transforming in-game resources stored on a single game platform into a single real-world resource, typically a government-backed fiat currency such as USD. However, there has been a growing demand for in-game resources to be converted into other resources, such as on-chain resources, which are digital in nature. Furthermore, existing technologies do not generally provide an incentive for game platforms to allow in-game resources from a game hosted by the game platform to be transformed, nor do they provide a user with an incentive to transform resources controlled by the user (e.g., real-world resources, in-game resources, or on-chain resources such as those stored on a blockchain) into another type of resource.

The systems and methods disclosed herein address these deficiencies by providing an integrated connectivity platform for transforming in-game resources into on-chain resources. This connectivity platform addresses the flexibility limitation of existing technologies by allowing a user of the connectivity platform to transform in-game resources from multiple games into one or more on-chain resources by interfacing with various game platforms and a transformation platform, which executes blockchain operations related to the transfer of various on-chain resources. The connectivity platform attributes resources from these various sources that are controlled by the user to a user account within the connectivity platform, centralizing management and accounting of transformations between these resources. The connectivity platform also links the various accounts associated with the user that grant access to these resources, streamlining the process of facilitating transformation requests. By effectively tracking the accounts and resources associated with each user, the connectivity platform may facilitate transformations for a plurality of users while attributing the resulting resources from each transformation request to the appropriate user.

The connectivity platform may perform the following operations when transforming in-game resources into on-chain resources. The connectivity platform may receive, from a game platform, a first transformation request to transform one or more in-game resources into one or more on-chain resources. The first transformation request may include a game identifier associated with a game, an amount of an in-game resource to transform, and an in-game account associated with a user. The game platform may host gameplay services for an online game, and the user may be logged in to the in-game account when the request is generated. For example, a player of an online game including in-game resources (e.g., Atlas Earth, Fortnite, Roblox) may be logged in to the game platform hosting that game and wish to transform an in-game resource from the game into an on-chain resource (e.g., a cryptocurrency like Bitcoin). This user may transmit, via the game platform, a first transformation request to transform an amount of the specified in-game resource into a specified on-chain resource.

After the connectivity platform receives the request, the connectivity platform may detect that a first amount of a real-world resource has been added to a first electronic repository associated with the connectivity platform. For example, this amount of a real-world resource may be transferred to the electronic repository by the game platform to cover the expense of the connectivity platform facilitating transformation of the in-game resource into the on-chain resource. In some embodiments, detecting the first amount of the real-world resource may include monitoring the electronic repository (e.g., over a network) for changes in real-world resources stored therein and detecting a change in real-world resources associated with the first transformation request. In other embodiments, detecting the amount of the real-world resource may include receiving a notification (e.g., over a network) from the electronic repository that a change in real-world resources within the electronic repository has been made and is associated with the first transformation request.

The connectivity platform may then increase a resource allocation count associated with the user based on the first amount of the real-world resource that was added to the first electronic repository. For example, the resource allocation count may represent the amount of the real-world resource the user is entitled to transform on account of the amount being attributed to the user's transformation requests. The connectivity platform may additionally determine a user account within the connectivity platform corresponding to the in-game account associated with the user. For example, the user account may be logged in to by the user to access the connectivity platform and may be used by the connectivity platform to track the various in-game accounts and resources associated with the user. In some embodiments, determining the user count may include searching an account database using the user account and identifying a link between the user account and the in-game account in the account database. In these and other embodiments, the connectivity platform may cause the display of a graphical user interface (GUI) for linking one or more in-game accounts within various game platforms with the user account.

The connectivity platform may generate, based on the resource allocation count, a second transformation request to transform a second amount of the real-world resource from the electronic repository into a corresponding set of on-chain resources and transmit this request to a transformation platform. For example, the transformation request may direct a transformation platform (e.g., a platform for transforming resources into on-chain resources and executing blockchain operations related to the transfer of on-chain resources) to execute a requested transformation using the second amount of the real-world resource, a transformation platform identifier associated with the user, and an indication of a type of the on-chain resources into which the second amount of the real-world resources is to be transformed. In some embodiments, the connectivity platform may receive an indication of the second amount of the real-world resource to transform from the user. For example, the connectivity platform may receive this indication via a transformation list GUI including a list of amounts of the real-world resource.

In some embodiments, the connectivity platform may receive an indication that the transaction platform has executed the second transformation request. The connectivity platform may then notify the user of the executed transformation and/or display information related to resources associated with the user so that the user may track the resources available to the user. For example, the connectivity platform may cause display of a transformation summary GUI indicating information about the executed request and/or other resources available to the user.

In some embodiments, the connectivity platform may generate a transfer request to transfer an amount of real-world resource from the first electronic repository to a second electronic repository associated with the game platform. For example, this transfer may represent a sharing between the game platform and the connectivity platform of the resources earned by the connectivity platform for facilitating a transformation, therefore incentivizing the game platform to allow in-game resources within a game it hosts to be transformed into other resources via the connectivity platform.

Existing transformation technologies may also lack a mechanism for linking in-game environments with transformations of real-world resources into on-chain resources and/or for executing other operations pertaining to on-chain resources. While existing transformation platforms, such as cryptocurrency trading platforms like Binance and Coinbase, may have incentives in place to encourage use of the platforms (e.g., gamified achievements and/or awards of real-world resources), these platforms do not link the execution of transformations by a user to an in-game account for a video game associated with the same user. Thus, transformation platforms and game platforms are currently unable to benefit from the strong incentive power of in-game resources to encourage users who play games to transform and/or transact on-chain resources.

The connectivity platform disclosed herein also overcomes this limitation by generating a request for a game platform to link an in-game resource with an in-game account. The in-game account may belong to a user of the connectivity platform who initiated a transformation request on a transformation platform. The connectivity platform may generate this request by receiving a notification that real-world resources have been received by the connectivity platform. For example, real-world resources such as USD or another fiat currency may be received in response to a completed transformation initiated by a user. The connectivity platform may also attribute that user with an amount of a connectivity platform resource (e.g., a virtual coin or token within the connectivity platform) representing a value that the user may transform into in-game resources of equivalent value. The user may then redeem these connectivity platform resources as in-game resources within one or more games via the connectivity platform. For example, a user who plays the game League of Legends may redeem an amount of the connectivity platform resource for RP, or virtual tokens, which can be exchanged for other in-game resources such as playable characters, character “skins,” and/or other cosmetic items. The ability to obtain these in-game resources may thereby provide the user with an incentive for executing transformations on the transformation platform.

The connectivity platform may perform the following operations when generating requests to link in-game resources with in-game accounts. The connectivity platform may receive, from a game platform, a notification that a first amount of a real-world resource has been added to a first electronic repository associated with a connectivity platform. The first amount of the real-world resource may have been added to the first electronic repository in response to a transformation platform transforming a second amount of the real-world resource into a corresponding set of on-chain resources. For example, the first amount of the real-world resource may be a percentage of the second amount of the real-world resource transferred to the electronic repository by the transformation platform in response to the connectivity platform facilitating the transformation. The notification may include the second amount of the real-world resource and a transformation platform account. The transformation platform account may be associated with a user of the connectivity platform who initiated the transformation request and may serve as a user identifier that links the user with assets within the transformation platform.

In some embodiments, the connectivity platform may identify a user account linked to the transformation platform account. The user account may be an account associated with the user within the connectivity platform. For example, the connectivity platform may identify the user account by searching an account database stored within the transformation platform using the transformation platform account. The account database may be searched via an API of the transformation platform.

The connectivity platform may determine a first transformation rate between a connectivity platform resource and the real-world resource. For example, the first transformation rate may indicate an amount of the real-world resource equivalent in value to one unit of the connectivity platform resource and thereby be used as the basis for transformations between the two resources. After determining the first transformation rate, the connectivity platform may modify a resource allocation count based on the second amount of the real-world resource and the first transformation rate. For example, the resource allocation count may indicate an amount of the connectivity platform resource attributed to the user's account within the connectivity platform. In some embodiments, in response to modifying the resource allocation count, the connectivity platform may generate a second transformation summary GUI. The second transformation summary GUI may indicate the resource allocation count, the second amount of the real-world resource, the corresponding set of on-chain resources into which the second amount of the real-world resource was transformed, and a summary of on-chain resources associated with the user.

The connectivity platform may then generate a GUI for selecting a game (e.g., hosted by a game platform) in which to receive an in-game resource. In some embodiments, the GUI may indicate the first transformation rate and/or a game identifier (e.g., a name, icon, or other identifier) associated with a game that may be selected via the GUI. Displaying the first transformation rate and/or the game identifier may allow the user to determine the amount of an in-game resource for a particular game that the user would receive for transforming a certain amount of the connectivity platform resource. In these and other embodiments, the GUI may include a list of games including an unlinked game for which the user does not have an existing in-game account. The unlinked game may be selected from a games database (e.g., a database including all games that have partnered with the connectivity platform) within the connectivity platform. For example, the unlinked game may be selected based on a number of previous selections of the unlinked game and/or a similarity (e.g., same genre or target age) between the unlinked game and a game for which the user does have an existing in-game account. In such an embodiment, the connectivity platform may receive a selection of an unlinked game from the user via the GUI and generate a prompt for the user to input a credential (e.g., password or other authenticator) used to generate a new in-game account associated with the user.

The connectivity platform may receive a selection of a game from the user. In some embodiments, the connectivity platform may then determine the existence of an in-game account for the selected game associated with a user account. For example, the connectivity platform may determine that the in-game account exists by searching an account database stored in the connectivity platform using the user account. As another example, the connectivity platform may cause the display of a GUI for linking one or more in-game accounts with the user account, receive a credential from the user via the GUI, transmit the credential to the game platform, and receive a verification of the in-game account's existence from the game platform.

The connectivity platform may determine a second transformation rate between the connectivity platform resource and an in-game resource within the selected game. The second transformation rate may indicate an amount of the connectivity platform resource equivalent in value to one unit of the selected in-game resource and thereby be used as the basis for transformations between the two resources. After determining the second transformation rate, the connectivity platform may generate, based on the resource allocation count and the second transformation rate, a transformation request. The transformation request may be a request for the game platform to link an amount of the in-game resource with the in-game account and may transmit the transformation request to the game platform. For example, the transformation request may be a request to transform an amount of real-world resources into an amount of the in-game resource. When the request is received by the game platform, the request may signal to the game platform that the game platform has been compensated for disbursing those in-game resources. In some embodiments, the transformation request may include a specification of a type of the in-game resource, the amount of the in-game resource, the in-game account, and the first electronic repository. In some embodiments, the transformation request may be transmitted to an API of the game platform that causes a transfer of a third amount of the real-world resource from the first electronic repository to a second electronic repository that is associated with the game platform (e.g., as compensation for the game platform partnering with the connectivity platform).

The game platform, in conjunction with the connectivity platform, may disburse the in-game resources in different ways, depending on the embodiment. For example, the game platform may generate a symbolic code (e.g., a gift card code or coupon code) that, when input into the game platform by a user logged in to an in-game account, will attribute the requested in-game resource to that in-game account. Continuing with the same example, the symbolic code may be received by the connectivity platform from the game platform, and the connectivity platform may then generate a presentation of the symbolic code to the user. As another example, the game platform may initially attribute the in-game resource to a second in-game account associated with the connectivity platform itself, and then the connectivity platform may generate a transfer request. The transfer request may be a request to transfer the amount of the in-game resource from the transformation request from the second in-game account to the user's in-game account, thereby ultimately attributing the in-game resource to the user's account.

In some embodiments, the connectivity platform may decrease the resource allocation count based on the second transformation rate and the amount of the in-game resource requested in the transformation request. For example, the connectivity platform may thereby decrease the connectivity platform resources attributed to the user in proportion to the value of the real-world resources spent to link the user's in-game account with the amount of the in-game resource.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 is an example environment for transforming in-game resources into on-chain resources and vice versa.

FIG. 2 is an example graphical user interface (GUI) for linking one or more in-game accounts with a user account.

FIG. 3 is an example transformation list GUI for displaying a list of previous transformation requests.

FIG. 4 is an example transformation summary GUI for displaying a summary of a completed transformation.

FIG. 5 is an example environment for obtaining in-game resources based on transformations of real-world resources into on-chain resources.

FIG. 6 is a second example transformation summary GUI for displaying a summary of a completed transformation.

FIG. 7 is an example GUI for selecting a game in which to receive an in-game resource.

FIG. 8 is an illustrative diagram for an example computing system.

FIG. 9 is an illustrative diagram for a decentralized environment for performing blockchain functions or operations.

FIG. 10 is a flowchart of operations for transforming in-game resources into on-chain resources.

FIG. 11 is a flowchart of operations for obtaining in-game resources based on transformations of real-world resources into on-chain resources.

### DETAILED DESCRIPTION

### Example Transformation Environment

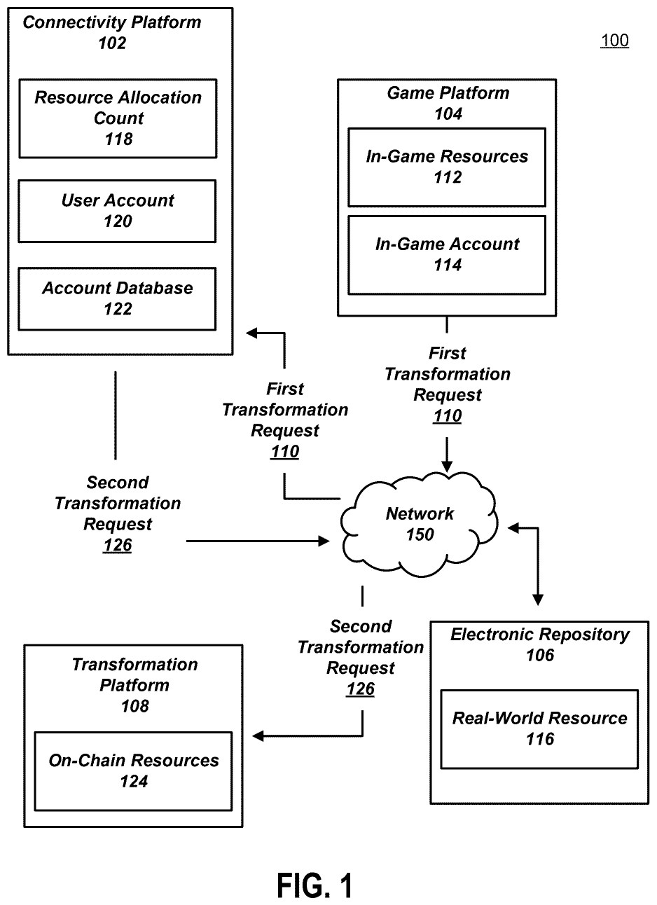

FIG. 1 is an example of environment 100 for transforming in-game resources into on-chain resources and vice versa. Environment 100 includes connectivity platform 102, game platform 104, electronic repository 106, transformation platform 108, and network 150. Connectivity platform 102 may execute instructions for transmitting a transformation request to transformation platform 108. Connectivity platform 102 may include software, hardware, or a combination of the two. For example, connectivity platform 102 may be hosted on a physical server or a virtual server that is running on a physical computer system. In some embodiments, connectivity platform 102 may be configured on a user device (e.g., a laptop computer, a smartphone, a desktop computer, an electronic tablet, or another suitable user device).

In some embodiments, connectivity platform 102 receives first transformation request 110 from game platform 104 over network 150. Network 150 may be a local area network, a wide area network (e.g., the Internet), or a combination of the two. First transformation request 110 may be a request to transform one or more in-game resources 112 into one or more on-chain resources 124. In-game resources 112 may be objects within a game hosted by game platform 104 that may be interacted with by a player of the game, such as a playable character, an item, a cosmetic token, and/or fungible in-game currency that may be exchanged for another in-game resource. On-chain resources 124 may be resources hosted on a blockchain, such as cryptocurrencies or non-fungible tokens, and which may be stored in cryptography-based storage applications, such as “cryptographic wallets.” Each cryptography-based storage application may store a private key associated with a corresponding user and may include software, hardware, or a combination of the two. For example, each cryptography-based storage application may include software executed on one or multiple devices or may include hardware such as a physical device. In some cases, a cryptography-based storage application may be software and may be stored in data nodes, and a user of the cryptography-based storage application may access the cryptography-based storage application online, e.g., via a browser. Additionally or alternatively, a cryptography-based storage application may reside on a general-purpose computer or on a special device (e.g., a fob) intended for storing the cryptography-based storage application. For example, the device may store private keys in a memory of the device and allow transactions to be completed on the device itself. Some examples of hardware cryptographic wallets include Ledger® and Trezor®. Software cryptographic wallets may include MetaMask® and others.

Game platform 104 may host gameplay services for a game (e.g., an online game accessible by a user via network 150). Game platform 104 may include software, hardware, or a combination of the two. For example, game platform 104 may be hosted on a physical server or a virtual server that is running on a physical computer system. In some embodiments, game platform 104 may be configured on a user device (e.g., a laptop computer, a smartphone, a desktop computer, an electronic tablet, or another suitable user device).

In some embodiments, first transformation request 110 may include a game identifier associated with the game hosted by game platform 104 (e.g., a name, icon, or another identifier distinguishing the game from other games), an amount of an in-game resource from in-game resources 112 to transform (e.g., a quantity of in-game currency), and in-game account 114 associated with a user. In-game account 114 may be an account associated with game platform 104 that may grant access to the user to play the game hosted by game platform 104. In these and other embodiments, the user associated with in-game account 114 may generate first transformation request 110 via game platform 104, may send first transformation request 110 to connectivity platform 102 over network 150 via game platform 104, and may be logged in to in-game account 114 when first transformation request 110 is generated.

Electronic repository 106 may store resources of value on behalf of entities associated with electronic repository 106 (e.g., individuals, organizations, and/or platforms such as connectivity platform 102, game platform 104, and transformation platform 108). In some embodiments, electronic repository 106 may store real-world resource 116, which is a fungible object of value used for transactions in the physical world (e.g., as opposed to a virtual environment like an online game). For example, real-world resource 116 may be a government-backed fiat currency (e.g., USD). In these and other embodiments, electronic repository 106 may be associated with connectivity platform 102.

In some embodiments, connectivity platform 102 detects that an amount of real-world resource 116 has been added to electronic repository 106. For example, detecting the amount of the real-world resource 116 may include monitoring electronic repository 106 (e.g., via connecting to electronic repository 106 over network 150) for changes in real-world resource 116 stored therein and detecting a change in real-world resource 116 associated with first transformation request 110. Continuing with the same example, detecting the change may include identifying that the change is associated with the amount of real-world resource 116 and in-game account 114 specified by first transformation request 110, thereby allowing connectivity platform 102 to associate the amount of real-world resource 116 with in-game account 114. As another example, detecting the amount of real-world resource 116 may include receiving a notification from electronic repository 106 that a change in real-world resources 116 within electronic repository 106 has been made. Continuing with this example, the notification may include an indication that the change is associated with the amount of real-world resource 116 and in-game account 114 specified by first transformation request 110, thereby allowing connectivity platform 102 to associate the amount of the real-world resource 116 with in-game account 114.

In some embodiments, connectivity platform 102 may include resource allocation count 118. Resource allocation count 118 may be a numerical representation of the amount of real-world resource 116 within electronic repository 106 associated with a user (e.g., an amount of real-world resource 116 attributed to the user and/or an amount for which the user is entitled to direct the usage/transfer). For example, when an amount of real-world resource 116 associated with first transformation request 110 is added to electronic repository 106, in-game account 114 associated with a user may be included in first transformation request 110. In such an example, the user may be entitled to the amount of real-world resource 116 added to electronic repository 106 in connection with first transformation request 110 on account of being the individual who initiated first transformation request 110. Thus, connectivity platform 102 may track the user's entitlement by increasing resource allocation count 118 associated with the user. Tracking resource allocation count 118 associated with the user allows electronic repository 106 to include amounts of real-world resource 116 associated with multiple users of connectivity platform 102 at once while allowing connectivity platform 102 to facilitate direction by each user of connectivity platform 102 of the usage or transfer of an amount of real-world resource 116 to which each user is entitled.

In some embodiments, connectivity platform 102 includes user account 120 associated with a user of connectivity platform 102. User account 120 may be used by the user to access connectivity platform 102 and send/receive transformation requests associated with in-game resources 112 and/or on-chain resources 124 via connectivity platform 102. In these and other embodiments, connectivity platform 102 may include account database 122 for storing various data associated with user accounts. Account database 122 may include software, hardware, or a combination of the two. For example, account database 122 may be a physical server or a virtual server that is running on a physical computer system. In some embodiments, connectivity platform 102 and account database 122 may reside on the same hardware and/or the same virtual server/computing device.

In some embodiments, connectivity platform 102 may determine that user account 120 is associated with the user by searching account database 122 stored in connectivity platform 102 using user account 120 (e.g., using text serving as a username for user account 120 as input for a search query of account database 122). In such embodiments, connectivity platform 102 may then identify a link between user account 120 and in-game account 114 (e.g., by detecting that data representing user account 120 and in-game account 114 are linked/grouped together in account database 122). Identifying the link allows connectivity platform 102 to verify that user account 120 is associated with the same user who initiated first transformation request 110 associated with in-game account 114 and therefore determine that user account 120 may likewise transform real-world resources 116 added to electronic repository 106 in response to first transformation request 110.

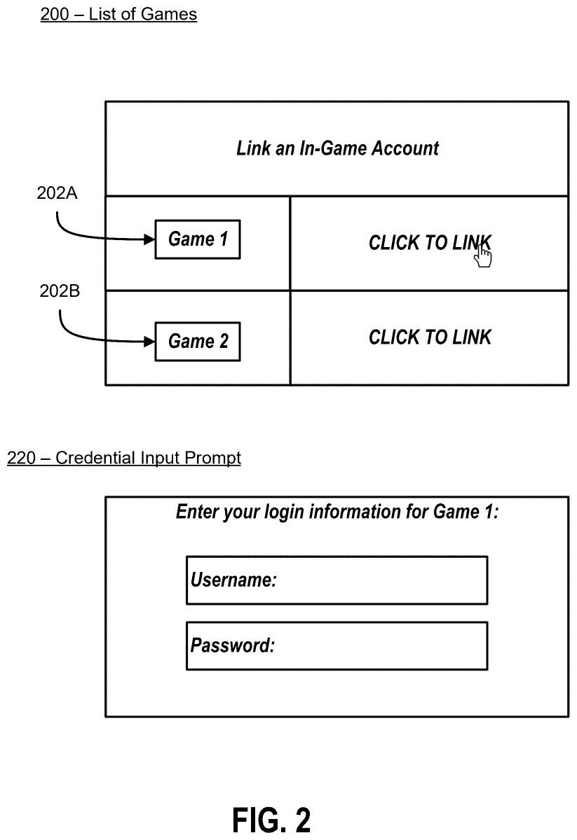

In some embodiments, connectivity platform 102 may cause the display of a GUI for linking one or more in-game accounts with user account 120. An example of such a GUI is illustrated in FIG. 2. The GUI may include list of games 200 for which in-game accounts within those games may be linked to user account 120, including the game hosted by game platform 104. Continuing with the same example, when the GUI receives a selection (e.g., by clicking a selection button using a mouse cursor, as illustrated in FIG. 2) of game identifier 202A or 202B (e.g., a name, icon, or other identifier) associated with one of the games in the list, the selection is received by connectivity platform 102, which generates and displays credential input prompt 220 to the user associated with user account 120. Credential input prompt 220 prompts the user to input a credential for the selected game. The credential is a personalized identifier (e.g., a password, username, biometric authenticator, security token, or combination thereof) used by the game platform hosting the selected game to verify that an in-game account within the game is associated with the user inputting the credential. Further continuing with the same example, connectivity platform 102 may transmit the credential input by the user to the corresponding game platform (e.g., via an application programming interface (API) of the game platform) and receive a verification from that game platform that a certain in-game account within the game is associated with the user. As another example, connectivity platform 102 may verify that the user is associated with an in-game account for the selected game using an authorization protocol (e.g., OAuth 2.0) that links the user to the in-game account using access tokens instead of direct transmission of a credential. Once this verification is received, connectivity platform 102 may link user account 120 with the in-game account (e.g., by grouping data associated with each account together in account database 122), allowing connectivity platform 102 to verify that transformations initiated by the in-game account are associated with user account 120. Linking user account 120 with the in-game account conserves computational resources across multiple transformation requests made by the user, as connectivity platform 102 may not have to repeatedly verify the existence and/or identity of an in-game account in the selected game associated with the user for subsequent transformation requests.

Transformation platform 108 transforms resources into on-chain resources 124 and executes blockchain operations related to the transfer of on-chain resources 124, such as the transfer of an on-chain resource from one cryptography-based storage application to another. For example, transformation platform 108 may include an API that other entities (e.g., connectivity platform 102) may interact with to direct transformation platform 108 to execute blockchain operations. Transformation platform 108 may include software, hardware, or a combination of the two. For example, transformation platform 108 may be hosted on a physical server or a virtual server that is running on a physical computer system. In some embodiments, transformation platform 108 may be configured on a user device (e.g., a laptop computer, a smartphone, a desktop computer, an electronic tablet, or another suitable user device). In some embodiments, transformation platform 108 may be hosted on a blockchain and may execute operations on a blockchain node. For example, transformation platform 108 may be a part of a smart contract or another on-chain program that is being executed by a blockchain node. In some embodiments, transformation platform 108 may be hosted on an independent computing device and may send requests to the blockchain node to execute instructions (e.g., retrieve cryptographic tokens, mint cryptographic tokens, etc.).

In some embodiments, connectivity platform 102 generates, based on resource allocation count 118, second transformation request 126 to transform an amount of real-world resource 116 from electronic repository 106 into a corresponding set of on-chain resources 124 (e.g., of an equivalent value to the amount of real-world resource 116) and transmits second transformation request 126 to transformation platform 108 (e.g., over network 150). Second transformation request 126 may include the desired amount of real-world resource 116 to transform, a transformation platform identifier (e.g., an account or other personalized identifier for transformation platform 108) associated with the same user as resource allocation count 118, and an indication of the type of on-chain resources 124 into which the amount of real-world resource 116 will be transformed. The elements comprising second transformation request 126 enable transformation platform 108 to associate the executed request with the user and may determine the particular on-chain resources 124 into which the amount of real-world resource 116 will be transformed, both in terms of type and quantity of each on-chain resource. For example, transformation platform 108 may transform the entire amount of real-world resource 116 into a single type of on-chain resource such that the quantity of that on-chain resource has an equivalent value to the amount of real-world resource 116. Additionally or alternatively, the set of on-chain resources 124 may include more than one type of on-chain resource and transformation platform 108 may transform part of the amount of real-world resource 116 into each type of on-chain resource.

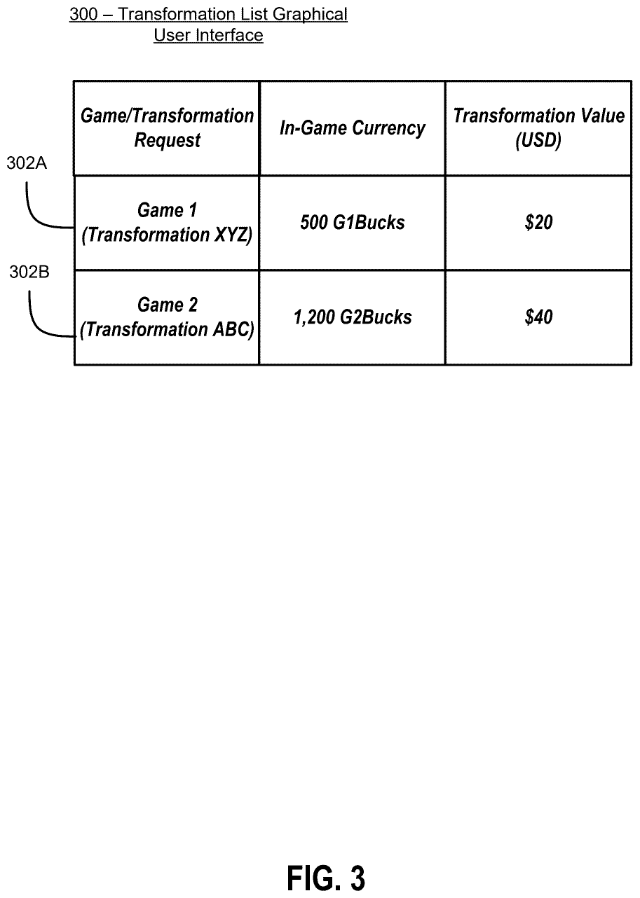

In some embodiments, connectivity platform 102 may receive an indication of the amount of the real-world resource 116 to transform from the user. For example, connectivity platform 102 may cause display of transformation list GUI 300 including a list of amounts of the real-world resource, as illustrated in FIG. 3. Each entry 302A, 302B in the list may correspond to a previous request to transform an amount of the real-world resource 116. As illustrated in FIG. 3, each entry may indicate (1) the amount of real-world resource 116 associated with the corresponding request, (2) an amount of an in-game resource associated with the corresponding request, and (3) a game identifier indicating the game from which the corresponding request originated.

In some embodiments, the list may only include entries 302A, 302B, where the corresponding request is associated with the user making second transformation request 126, and the user may select at least one of the amounts of real-world resource 116 displayed in the list. In such embodiments, connectivity platform 102 may base the amount of real-world resource requested in second transformation request 126 on a total of the amounts selected by the user. Because the amounts may only include amounts from previous transformation requests associated with the user, the user may not select an amount larger than the amount of real-world resource 116 added to electronic repository 106 as a result of the user's own transformation requests. Thus, connectivity platform 102 may allow each user of connectivity platform 102 to request the transformation of real-world resource 116 while preventing each user from transforming real-world resources associated with other users.

In some embodiments, after executing second transformation request 126, transformation platform 108 may notify connectivity platform 102 (e.g., via network 150) that second transformation request 126 was executed. In response, connectivity platform 102 may notify the user of the executed transformation and/or display information related to resources associated with the user so that the user may track the resources available to the user. For example, connectivity platform 102 may cause display of transformation summary GUI 400 indicating amount 402 of real-world resource 116 transformed in relation to second transformation request 126, set 404 of on-chain resources 124 acquired by executing second transformation request 126, and/or summary 406 of on-chain resources 124 associated with the user. Summary 406 may include a total value of the on-chain resources 124 associated with the user (e.g., reported in terms of a cryptocurrency or fiat currency) and/or a list of on-chain resources 124 associated with the user within transformation platform 108, which may be categorized by type of on-chain resource such that the user may track the amount of each on-chain resource the user is entitled to transact. Continuing with the same example, the list of on-chain resources 124 may be obtained via an API of transformation platform 108.

Additionally or alternatively, connectivity platform 102 may generate a transfer request to transfer an amount of real-world resource 116 from electronic repository 106 to a second electronic repository. The second electronic repository may have the same or a generally similar structure to electronic repository 106, except that the second electronic repository is associated with game platform 104 rather than connectivity platform 102. In such embodiments, connectivity platform 102 may transmit the transfer request to electronic repository 106 and decrease resource allocation count 118 based on the amount of real-world resource 116 to be transferred to the second electronic repository. In doing so, connectivity platform 102 may share the real-world resource 116 added as a result of first transformation request 110 with game platform 104, incentivizing game platform 104 to enable future transformation requests to be transmitted to connectivity platform 102. Furthermore, connectivity platform 102 may share real-world resource 116 with game platform 104 without disrupting the allocation of real-world resources in electronic repository 106 to users, as resource allocation count 118 is reduced to account for the decreased availability of real-world resource 116 after the transfer request is executed.

### Example Environment for Obtaining in-Game Resources

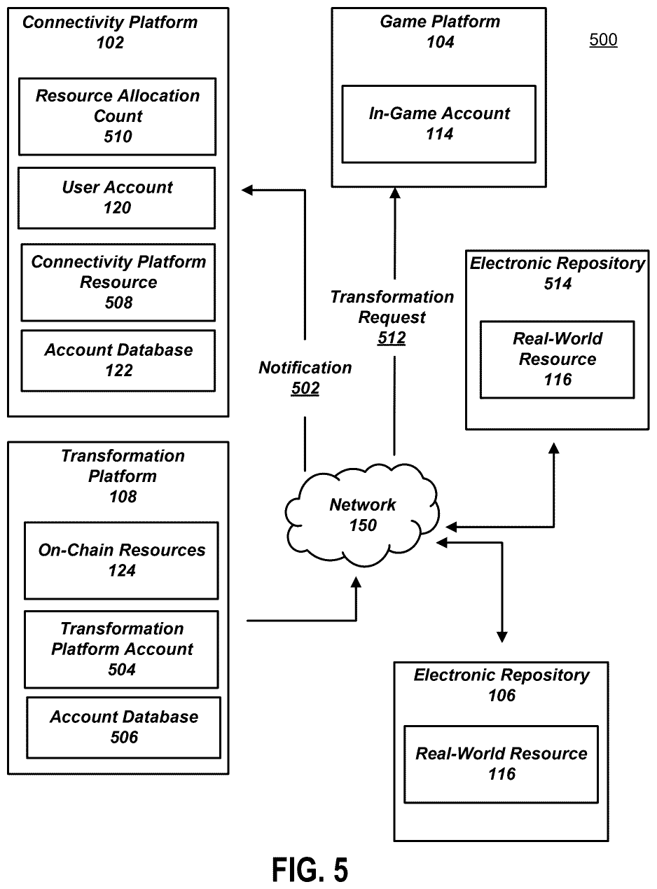

FIG. 5 is an example of environment 500 for obtaining in-game resources based on transformations of real-world resources into on-chain resources. Environment 500 includes connectivity platform 102, game platform 104, electronic repository 106, transformation platform 108, electronic repository 514, and network 150. Connectivity platform 102 may execute instructions for transmitting a transformation request to game platform 104.

In some embodiments, connectivity platform 102 receives notification 502 over network 150. For example, notification 502 may be sent over network 150 by electronic repository 106 or game platform 104. Notification 502 may be a notification that a first amount of real-world resource 116 has been added to electronic repository 106 associated with connectivity platform 102. In such embodiments, notification 502 may be sent in response to the first amount of real-world resource 116 being added to electronic repository 106 in response to transformation platform 108 transforming a second amount of real-world resource 116 into a corresponding set of on-chain resources 124. In these and other embodiments, notification 502 may specify the second amount of real-world resource 116 and/or transformation platform account 504. Transformation platform account 504 may be an account within transformation platform 108 associated with a user of connectivity platform 102 used by transformation platform 108 and/or connectivity platform 102 to attribute transformations of resources executed by transformation platform 108 to the user.

In some embodiments, connectivity platform 102 may identify that user account 120 is linked to transformation platform account 504. For example, connectivity platform 102 may search account database 506 using transformation platform account 504 (e.g., using text serving as a username for transformation platform account 504 as input for a search query of account database 506). Account database 506 may be included in transformation platform 108 for storing various data associated with transformation platform accounts. Account database 506 may include software, hardware, or a combination of the two. For example, account database 506 may be a physical server or a virtual server that is running on a physical computer system. In some embodiments, transformation platform 108 and account database 506 may reside on the same hardware and/or the same virtual server/computing device. In some embodiments, connectivity platform 102 may search account database 506 via an API of transformation platform 108.

In some embodiments, connectivity platform 102 may include connectivity platform resource 508. Connectivity platform resource 508 is a resource representing value within connectivity platform 102 that users of connectivity platform 102 may transform into in-game resources for various games. For example, in-game resources may include a fungible in-game currency that acts as a unit of value within a game and may be exchanged for other in-game resources within the game. In such embodiments, connectivity platform 102 may determine a first transformation rate between connectivity platform resource 508 and real-world resource 116. For example, the first transformation rate may indicate an amount of real-world resource 116 equivalent in value to one unit of connectivity platform resource 508 and thereby be used as the basis for transformations between the two resources. In some embodiments, the first transformation rate may be fixed by an entity operating connectivity platform 102.

In some embodiments, connectivity platform 102 may include resource allocation count 510. Resource allocation count 510 may be a numerical representation of the amount of connectivity platform resource 508 within connectivity platform 102 associated with a user (e.g., an amount of connectivity platform resource 508 attributed to the user and/or an amount for which the user is entitled to direct the usage/transfer). For example, when the first amount of real-world resource 116 associated with notification 502 is added to electronic repository 106, connectivity platform 102 may share the value of the first amount of real-world resource 116 with the user who initiated the transformation resulting in notification 502. In such an example, however, the user may be given an amount of connectivity platform resource 508 rather than being given real-world resource 116 directly. Connectivity platform 102 may determine the amount of connectivity platform resource 508 to attribute to the user based on the first amount of real-world resource 116 (e.g., which is used by connectivity platform 102 to limit the value attributed to the user to the value of the amount of real-world resource 116 that connectivity platform 102 has received itself) and the first transformation rate (e.g., which is used by connectivity platform 102 to determine amounts of connectivity platform resource 508 equivalent in value to amounts of real-world resource 116). Connectivity platform 102 may then attribute this amount of connectivity platform resource 508 to the user by increasing resource allocation count 510 associated with the user by the same amount. Tracking resource allocation count 510 associated with the user allows connectivity platform 102 to include amounts of connectivity platform resource 508 associated with multiple users of connectivity platform 102 at once while allowing connectivity platform 102 to facilitate direction by each user of connectivity platform 102 of the usage or transfer of an amount of connectivity platform resource 508 to which each user is entitled.

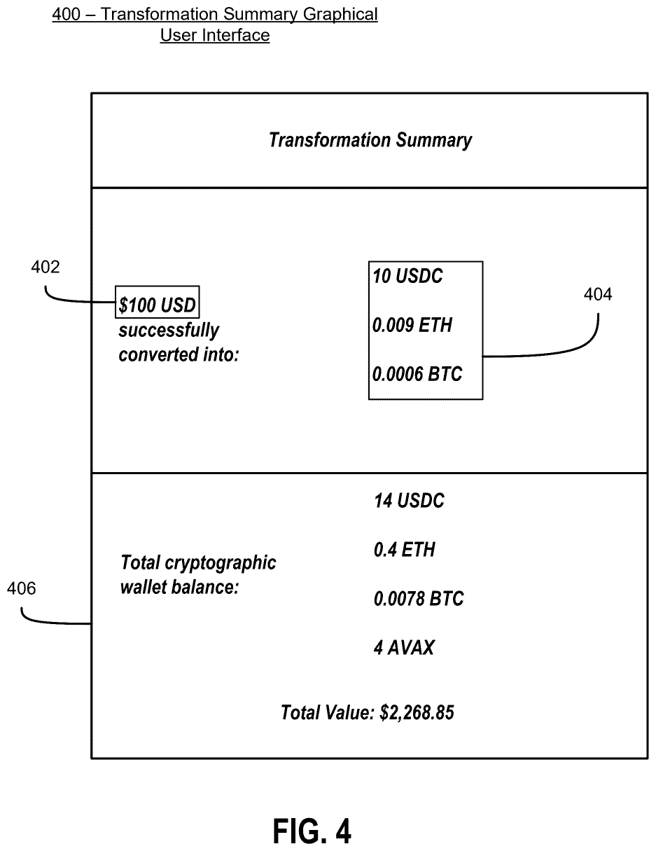

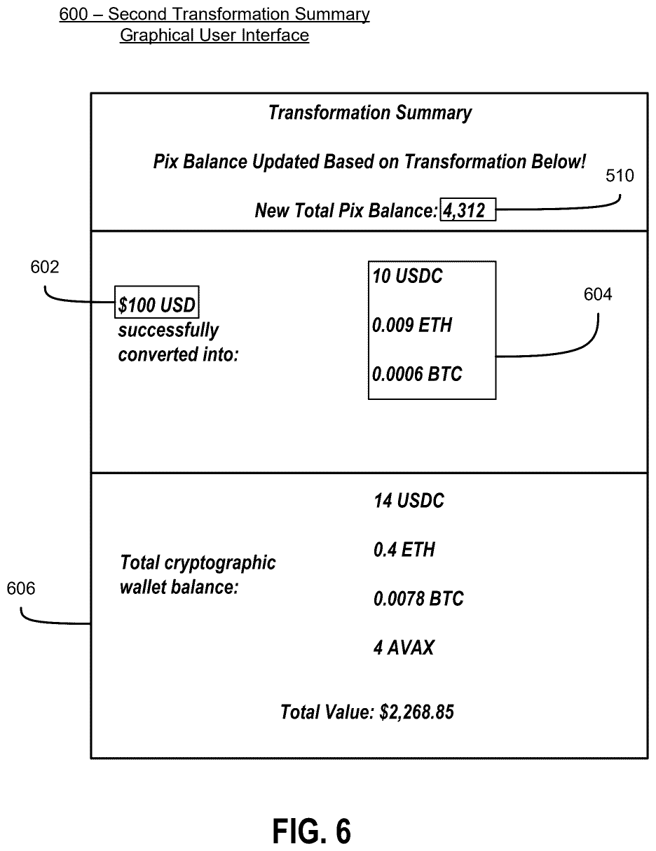

In some embodiments, in response to modifying resource allocation count 510, connectivity platform 102 may generate second transformation summary GUI 600, as depicted in FIG. 6. Transformation summary GUI 600 may indicate resource allocation count 510, the second amount 602 of real-world resource 116, the corresponding set 604 of on-chain resources 124 into which second amount 602 of real-world resource 116 was transformed, and a summary 606 of on-chain resources 124 associated with the user. Summary 606 may be the same or generally similar to summary 406 described in relation to FIG. 4 above. The indication of resource allocation count 510 may include a confirmation that resource allocation count 510 has been modified based on transformation platform 108 transforming second amount 602 of real-world resource 116 into the corresponding set 604 of on-chain resources 124.

In some embodiments, connectivity platform 102 may generate a GUI for selecting a game in which to receive an in-game resource. For example, the game may be hosted by game platform 104 or another game platform with the same or a generally similar structure. In some embodiments, the GUI indicates the first transformation rate and/or a game identifier (e.g., a name, icon, or other identifier) associated with a game that may be selected via the GUI. Displaying the first transformation rate and/or the game identifier may allow the user to determine the amount of an in-game resource for a particular game that the user would receive for transforming a certain amount of connectivity platform resource 508, informing the user's decision regarding the game in which to receive the in-game resource. In these and other embodiments, the user may be logged in to user account 120 when the GUI is presented to the user.

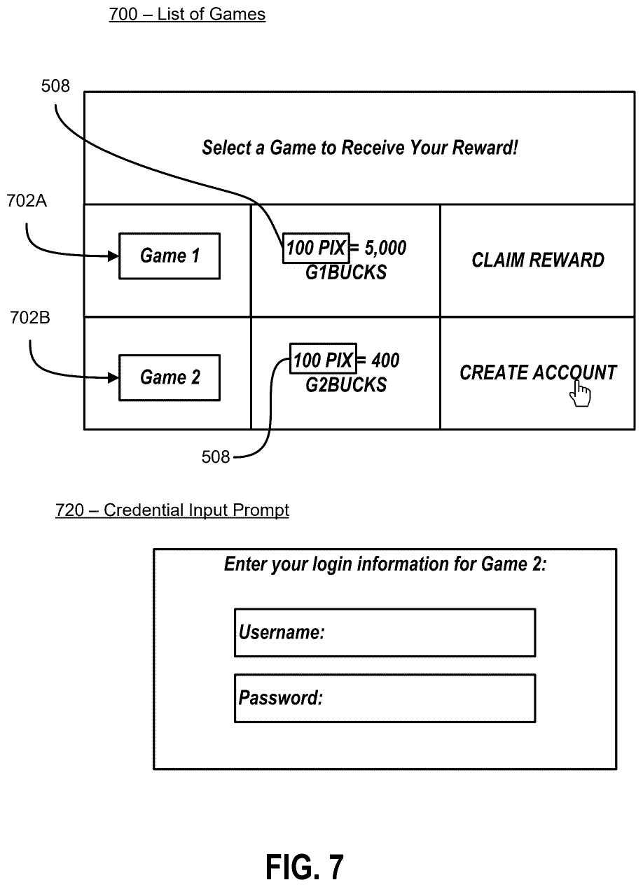

In some embodiments, the GUI may include a list of games 700 including at least one unlinked game for which the user does not have an existing in-game account. An example of such an embodiment of the GUI is illustrated in FIG. 7. The list of games 700 includes two game identifiers 702A, 702B for different games and includes a transformation rate between connectivity platform resource 508 (called “Pix” in FIG. 7) and an in-game resource for both of the listed games. Either game may be selected by the user (e.g., by clicking a selection button using a mouse cursor, as illustrated in FIG. 7), but the list of games 700 indicates that “Game 2” is currently an unlinked game, as denoted by the display of “Create Account” instead of “Claim Reward” for “Game 2.”

In some embodiments, the unlinked game displayed is selected by connectivity platform 102 from a games database within connectivity platform 102. The games database may be a database for storing various data associated with games that may appear in the list of games 700 and/or that connectivity platform 102 may link to user account 120. The games database may include software, hardware, or a combination of the two. For example, the games database may be a physical server or a virtual server that is running on a physical computer system. In some embodiments, connectivity platform 102 and the games database may reside on the same hardware and/or the same virtual server/computing device. In such embodiments, connectivity platform 102 may select an unlinked game from the games database based on a number of previous selections of the unlinked game. For example, the previous selections may be previous selections by other users of connectivity platform 102 to receive an in-game resource in the unlinked game, thus indicating the unlinked game is popular amongst users of connectivity platform 102 and therefore potentially of interest to the user presently making a selection. Additionally or alternatively, connectivity platform 102 may select an unlinked game based on a similarity between the unlinked game and a game for which the user does have an existing in-game account. For example, the similarity may be a measured similarity between the demographics of players of the two games (e.g., age, sex, race, or income) and/or may be membership in the game genre of game (e.g., platformer, shooter, or puzzle). By selecting based on the similarity, connectivity platform 102 causes display of a game that is likely to have similar gameplay to a game the user already plays and therefore also may be of interest to that user.

In some embodiments, when the user selects a game from the list of games 700, the selection is received by connectivity platform 102, which generates and displays credential input prompt 720 to the user associated with user account 120. Credential input prompt 720 prompts the user to input a credential for the selected game. The credential is a personalized identifier (e.g., a password, username, biometric authenticator, security token, or combination thereof) used by the game platform hosting the selected game to create a new in-game account associated with the user within the game platform. Further continuing with the same example, connectivity platform 102 may input the credential from the user into the corresponding game platform (e.g., via an API of the game platform) and receive a verification from that game platform that the new in-game account has been created. Once this verification is received, connectivity platform 102 may link user account 120 with the in-game account (e.g., by grouping data associated with each account together in account database 122), allowing connectivity platform 102 to verify the in-game account to which in-game resources should be attributed. Linking user account 120 with the in-game account conserves computational resources across multiple transformation requests made by the user, as connectivity platform 102 may not have to repeatedly verify the existence and/or identity of an in-game account in the selected game associated with the user for subsequent transformation requests.

In some embodiments, connectivity platform 102 may receive, via the GUI, a selection of a game from the user and then determine the existence of an in-game account for the selected game associated with user account 120. For example, the selected game may be a game hosted by game platform 104, and connectivity platform 102 may determine that in-game account 114 exists and is associated with user account 120 (e.g., on account of being associated with the same user as user account 120) by searching account database 122 stored in connectivity platform 102 using user account 120 (e.g., using text serving as a username for user account 120 as input for a search query of account database 122). In such embodiments, connectivity platform 102 may then identify a link between user account 120 and in-game account 114 (e.g., by detecting that data representing user account 120 and in-game account 114 are linked/grouped together in account database 122). Identifying the link allows connectivity platform 102 to verify that in-game account 114 is associated with the same user who is logged in to user account 120 and entitled to transform an amount of connectivity platform resource 508 into an in-game resource for the selected game. As another example, connectivity platform 102 may cause the display of a GUI for linking one or more in-game accounts with user account 120, such as the GUI illustrated in FIG. 2, and link user account 120 with in-game account 114 in the same manner as described above in relation to FIG. 2.

In some embodiments, connectivity platform 102 may determine a second transformation rate between connectivity platform resource 508 and an in-game resource within the selected game. For example, in embodiments where the selected game is hosted by game platform 104, the in-game resource may be a resource from in-game resources 112. The second transformation rate may indicate an amount of connectivity platform resource 508 equivalent in value to one unit of the selected in-game resource and thereby be used as the basis for transformations between the two resources. In some embodiments, the second transformation rate may be fixed by an entity operating connectivity platform 102. In other embodiments, connectivity platform 102 may adjust the second transformation rate dynamically in response to a number of selections by users to transform connectivity platform resource 508 into the in-game resource. For example, a low number of selections of the game may indicate that the second transformation rate does not offer a desirable value to users of connectivity platform 102, and thus connectivity platform 102 may adjust the second transformation rate such that the same amount of connectivity platform resource 508 may be transformed into more of the in-game resource.

In some embodiments, connectivity platform 102 may generate, based on resource allocation count 510 and the second transformation rate, transformation request 512 for game platform 104 to link an amount of the in-game resource with in-game account 114. For example, transformation request 512 may include a specification of a type of the in-game resource (e.g., an indication of whether the in-game resource is a playable character, fungible in-game currency, or other in-game resource), an amount of the in-game resource, in-game account 114, and electronic repository 106. Specifying each of these in transformation request 512 enables transformation request 512 to provide sufficient information to game platform 104, allowing game platform 104 to attribute the in-game resource selected by the user to in-game account 114 and receive the amount of the in-game resource in exchange for doing so.

In some embodiments, connectivity platform 102 may transmit transformation request 512 to an API of game platform 104 (e.g., over network 150). In such embodiments, connectivity platform 102 may cause, via the API, the transfer of a third amount of real-world resource 116 from electronic repository 106 to electronic repository 514. Electronic repository 514 may have the same or a generally similar structure to electronic repository 106, except that electronic repository 514 is associated with game platform 104 rather than connectivity platform 102. The third amount of real-world resource 116 may be determined based on the first and second transformation rates and/or be determined to be equivalent in value to the amount of the in-game resource attributed to in-game account 114. Thus, game platform 104 may be compensated for attributing the in-game resource to in-game account 114 by receiving real-world resource 116 from electronic repository 106 associated with connectivity platform 102.

In some embodiments, game platform 104 may not attribute the real-world resource to in-game account 114 directly but may execute further interactions with connectivity platform 102 in order to finalize this attribution. For example, game platform 104 may, in response to transformation request 512, generate a symbolic code that, when input into game platform 104 by a user logged in to an in-game account, may attribute the requested in-game resource to that in-game account. Continuing with the same example, the symbolic code may be sent by game platform 104 to connectivity platform 102, which may then receive the symbolic code and generate a presentation of the symbolic code to the user. The user may then enter the code while logged in to in-game account 114 to gain access to the in-game resource. As another example, game platform 104 may initially attribute the in-game resource to a second in-game account associated with connectivity platform 102 itself, and then connectivity platform 102 may generate a transfer request to transfer the amount of the in-game resource from transformation request 512 from the second in-game account to in-game account 114. Continuing with the same example, the transfer request may include a specification of each of the amount of the in-game resource to transfer and of the two in-game accounts, enabling the game platform to transfer the appropriate amount of the in-game resource between the accounts. The transfer request may cause, via an API of the game platform, the amount of the in-game resource to be transferred from the second in-game account to in-game account 114 in response to the transfer request.

In some embodiments, connectivity platform 102 may decrease the resource allocation count based on the second transformation rate and the amount of the in-game resource requested in transformation request 512. In doing so, connectivity platform 102 may avoid transforming more of connectivity platform resource 508 on behalf of the user than the user is entitled to control, allowing connectivity platform 102 to manage transformation requests from multiple users without depleting more than the amount of connectivity platform resource 508 and/or real-world resource 116 to which each user is entitled.

### Example Computing Environment

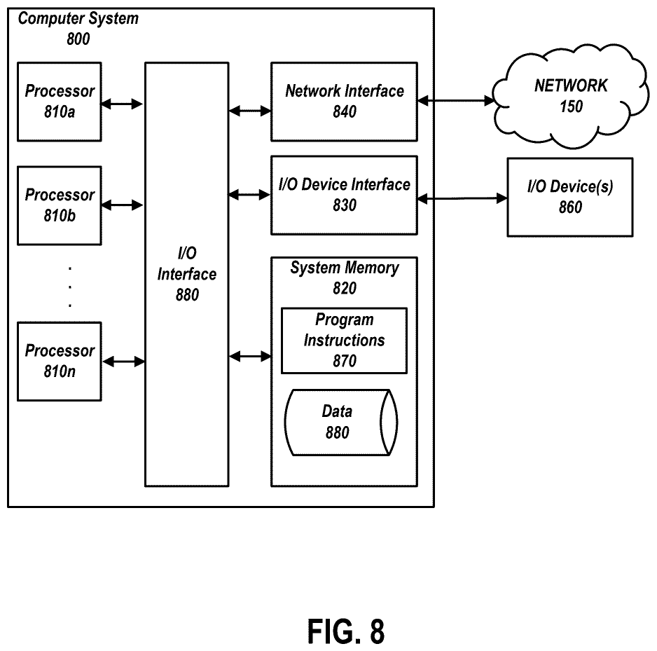

FIG. 8 shows an example computing system that may be used in accordance with some embodiments of this disclosure. In some instances, computing system 800 is referred to as a computer system 800. A person skilled in the art would understand that those terms may be used interchangeably. The components of FIG. 8 may be used to perform some or all operations discussed in relation to FIGS. 1-7. Furthermore, various portions of the systems and methods described herein may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output (I/O) device interface 830, and a network interface 840 via an I/O interface 880. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special-purpose microprocessors. A processor may receive instructions and data from a memory (e.g., system memory 820). Computing system 800 may be a uni-processor system including one processor (e.g., processor 810a) or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special-purpose logic circuitry, e.g., an FPGA (field-programmable gate array) or an ASIC (application-specific integrated circuit). Computing system 800 may include a plurality of computing devices (e.g., distributed computer systems) to implement various processing functions.

I/O device interface 830 may provide an interface for connection of one or more I/O devices 860 to computer system 800. I/O devices may include devices that receive input (e.g., from a user) or output information (e.g., to a user). I/O devices 860 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computer system 800 through a wired or wireless connection. I/O devices 860 may be connected to computer system 800 from a remote location. I/O devices 860 located on remote computer systems, for example, may be connected to computer system 800 via a network and network interface 840.

Network interface 840 may include a network adapter that provides for connection of computer system 800 to a network. Network interface 840 may facilitate data exchange between computer system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Program instructions 870 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random-access memory (RAM), static random-access memory (SRAM), synchronous dynamic RAM (SDRAM)), bulk storage memory (e.g., CD-ROM and/or DVD-ROM, hard drives), or the like. System memory 820 may include a non-transitory, computer-readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices).

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 800 or multiple computer systems 800 configured to host different portions or instances of embodiments. Multiple computer systems 800 may provide for parallel or sequential processing/execution of one or more portions of the techniques described herein.

Those skilled in the art will appreciate that computer system 800 is merely illustrative and is not intended to limit the scope of the techniques described herein. Computer system 800 may include any combination of devices or software that may perform or otherwise provide for the performance of the techniques described herein. For example, computer system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 800 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Blockchain Environment

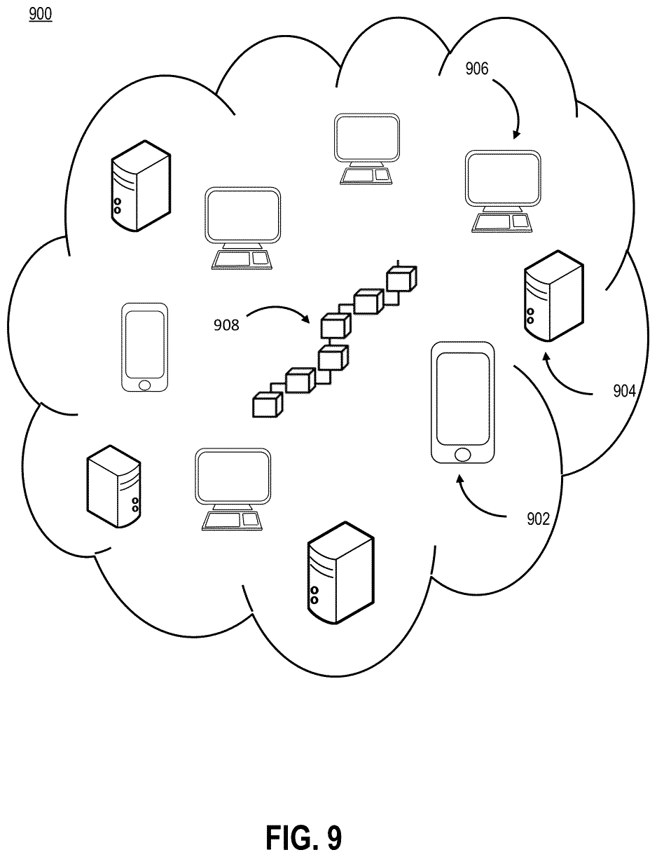

FIG. 9 shows an illustrative diagram for a decentralized environment for performing blockchain functions or operations, in accordance with one or more embodiments. For example, the diagram presents various components that may be used to allocate and distribute cryptographic resources in response to an off-chain trigger or event upon request in some embodiments.

As shown in FIG. 9, system 900 may include multiple user devices (e.g., user device 902, user device 904, and/or user device 906). For example, system 900 may include a distributed state machine in which each of the components in FIG. 9 acts as a client of system 900. For example, system 900 (as well as other systems described herein) may include a large data structure that holds not only all accounts and balances but also a state machine that may change from block to block according to a predefined set of rules and that may execute arbitrary machine code. The specific rules of changing state from block to block may be maintained by a virtual machine (e.g., a computer file implemented on and/or accessible by a user device, which behaves like an actual computer) for the system. For example, system 900 may interact with, and facilitate the function of, blockchain 908.

It should be noted that, while shown as a smartphone, a personal computer, and a server in FIG. 9, the user devices may be any type of computing device, including, but not limited to, a laptop computer, a tablet computer, a handheld computer, and/or other computing equipment (e.g., a server), including “smart,” wireless, wearable, and/or mobile devices. It should be noted that embodiments describing system 900 performing a blockchain function may equally be applied to, and correspond to, an individual user device (e.g., user device 902, user device 904, and/or user device 906) performing the blockchain function. That is, system 900 may correspond to the user devices (e.g., user device 902, user device 904, and/or user device 906) collectively or individually.

Each of the user devices may be used by the system to conduct blockchain functions or operations and/or contribute to allocating and distributing cryptographic resources in response to an off-chain trigger or event upon request. As referred to herein, “blockchain functions” or “blockchain operations” may include any operations including and/or related to blockchains and blockchain technology. For example, blockchain functions or operations may include conducting transactions, querying a distributed ledger, generating additional blocks for a blockchain, transmitting communications-related nonfungible tokens, performing encryption/decryption, exchanging public/private keys, and/or other operations related to blockchains and blockchain technology. In some embodiments, a blockchain function or operation may include the creation, modification, detection, and/or execution of a smart contract or program stored on a blockchain. For example, a smart contract may include a program stored on a blockchain that is executed (e.g., automatically, without any intermediary's involvement or time loss) when one or more predetermined conditions are met. In some embodiments, a blockchain function may include the creation, modification, exchange, and/or review of a token (e.g., a digital blockchain-specific asset), including a nonfungible token. A nonfungible token may include a token that is associated with a good, a service, a smart contract, and/or other content that may be verified by, and stored using, blockchain technology.

In some embodiments, blockchain functions or operations may also include actions related to mechanisms that facilitate other blockchain functions (e.g., actions related to metering activities for blockchain functions on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain function (e.g., computation, data access, transaction, etc.). Each blockchain function has a predetermined cost in units of gas (e.g., as determined based on a predefined set of rules for the system). When a blockchain function triggers the execution of a smart contract, the blockchain function may include an amount of gas that sets the upper limit of what may be consumed in running the smart contract. The system may terminate execution of the smart contract if the amount of gas consumed by computation exceeds the gas available in the blockchain function. For example, in Ethereum, gas includes a mechanism for enabling Turing-complete computation while limiting the resources that any smart contract and/or blockchain function may consume.

In some embodiments, gas may be obtained as part of a blockchain function or operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 9, one or more user devices may include a digital wallet (e.g., cryptography-based storage application described above) used to perform blockchain functions or operations. For example, the digital wallet may include a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets, such as hot wallets and cold wallets. Hot wallets are connected to the Internet, while cold wallets are not. Most digital wallet holders hold both a hot wallet (e.g., residing on a computing device) and a cold wallet (residing on a device that is generally disconnected from a computing device and is not accessible until connected). Hot wallets are most often used to perform blockchain functions, while a cold wallet is generally used for managing a user account and may have no connection to the Internet.

One or more user devices may include a private key and a public key. In such cases, each pair includes a public key (e.g., which may be public) and a private key (e.g., which may be kept private). Key pairs may be generated using cryptographic algorithms (e.g., featuring one-way functions). Computing devices may then encrypt a message using an intended receiver's public key such that the encrypted message may be decrypted only with the receiver's corresponding private key. In some embodiments, a message may be used in combination with a private key to create a digital signature on the message. For example, the digital signature may be used to verify the authenticity of blockchain functions or operations. As an illustration, when conducting blockchain functions, the digital signature may be used to prove to every node in the system that it is authorized to conduct the blockchain functions.

For example, system 900 may include a plurality of nodes for the blockchain network. A node for a blockchain network may include an application or other software that records and/or monitors peer connections to other nodes and/or miners for the blockchain network. For example, a miner includes a node in a blockchain network that facilitates blockchain functions by verifying blockchain functions or operations on the blockchain, adding new blocks to the existing chain, and/or ensuring that these additions are accurate. The nodes may continually record the state of the blockchain and respond to remote procedure requests for information about the blockchain.

Following an authentication of the blockchain function, the blockchain function may be authorized. For example, after the blockchain function is authenticated between the users, system 900 may authorize the blockchain function prior to adding it to the blockchain. Blockchain functions or operations may be added to blockchain 908 via blockchain nodes. The blockchain may perform this (via blockchain nodes) based on a consensus within the blockchain network. For example, system 900 may rely on a majority (or other metric) of the nodes in the community network to determine that the blockchain function or operation is valid. In response to validation of the block, a blockchain node in the community network (e.g., a miner) may receive a reward (e.g., in a given cryptocurrency) as an incentive for validating the block.

To validate the blockchain function, a blockchain node may use one or more validation protocols and/or validation (or consensus) mechanisms. For example, a blockchain node may use a Proof of Work (POW) mechanism in which a user device must provide evidence that it performed computational work to validate a blockchain function, and thus this mechanism provides for achieving consensus in a decentralized manner as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively or additionally, a blockchain node may use a Proof of Stake (POS) mechanism in which a user account (e.g., corresponding to a node on the blockchain network) is required to have, or “stake,” a predetermined amount of tokens in order to be recognized as a validator in the blockchain network. In response to validation of the block, the block is added to blockchain 908, and the blockchain function is completed. For example, to add the blockchain function to blockchain 908, the successful node (e.g., the successful miner) encapsulates the blockchain function in a new block before committing it to the blockchain.

### Example Operation Flows

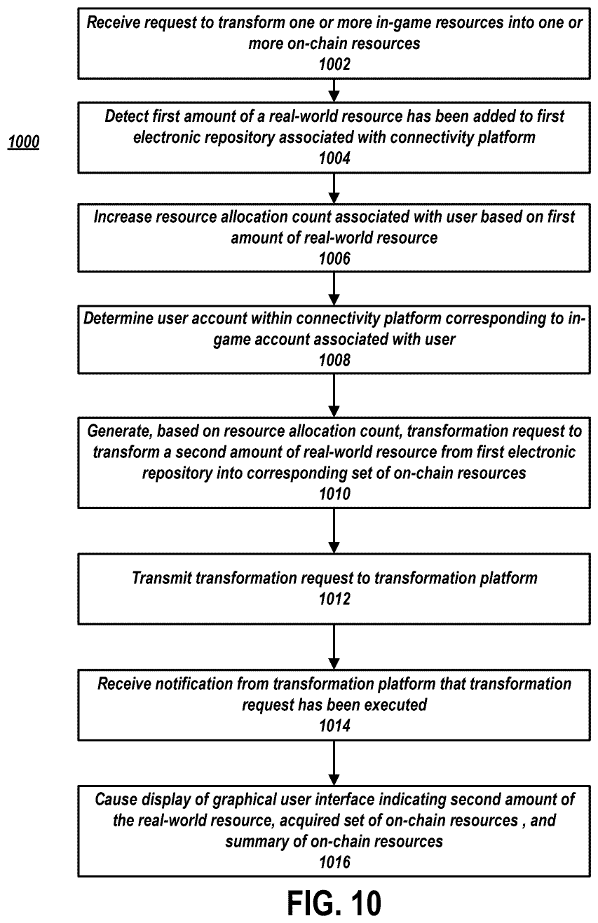

FIG. 10 is a flowchart of operations 1000 for transforming in-game resources into on-chain resources. The operations of FIG. 10 may use components described in relation to FIG. 8 and/or FIG. 9. In some embodiments, connectivity platform 102 may include one or more components of computer system 800. At 1002, connectivity platform 102 receives a request to transform one or more in-game resources into one or more on-chain resources. For example, connectivity platform 102 may receive, from game platform 104, one or more transformation requests. Connectivity platform 102 may receive the one or more transformation requests using network interface 840 over network 150.

At 1004, connectivity platform 102 detects that a first amount of a real-world resource has been added to a first electronic repository associated with connectivity platform 102. For example, connectivity platform 102 may use one or more processors 810a, 810b, and/or 810n and/or network interface 840 to monitor the first electronic repository over network 150. As an additional example, connectivity platform 102 may use one or more processors 810a, 810b, and/or 810n and/or network interface 840 to receive a notification from the first electronic repository that a change in real-world resources within the first electronic repository has been made. In some embodiments, the real-world resource may be the same as or generally similar to real-world resource 116 and the first electronic repository may be the same as or generally similar to electronic repository 106.

At 1006, connectivity platform 102 increases a resource allocation count associated with a user based on the first amount of the real-world resource. For example, connectivity platform 102 may use one or more processors 810a, 810b, and/or 810n to extract the resource allocation count from system memory 820 and store the increased resource allocation account in system memory 820. In some embodiments, the resource allocation count is increased based on the amount of the real-world resource that was added to the first electronic repository and detected in 1004.

At 1008, connectivity platform 102 determines a user account within connectivity platform 102 corresponding to an in-game account associated with the user. Connectivity platform 102 may use one or more processors 810a, 810b, and/or 810n to make the determination, and the determination may include searching an account database stored in system memory 820. At 1010, connectivity platform 102 generates, based on the resource allocation count, a transformation request to transform a second amount of the real-world resource from the first electronic repository into a corresponding set of on-chain resources. Connectivity platform 102 may use one or more processors 810a, 810b, and/or 810n to generate the transformation request. At 1012, connectivity platform 102 transmits the transformation request to transformation platform 108. For example, connectivity platform 102 may transmit the transformation request to transformation platform 108 via network interface 840 over network 150.

At 1014, connectivity platform 102 receives a notification from transformation platform 108 that the transformation request has been executed. For example, the notification may be received via network interface 840 over network 150 and/or stored in system memory 820. At 1016, connectivity platform 102 causes display of a GUI indicating the second amount of the real-world resource, an acquired set of on-chain resources, and a summary of on-chain resources associated with the user. For example, connectivity platform 102 may use one or more processors 810a, 810b, and/or 810n to cause display of the graphical user interface, which may be displayed on I/O device(s) 860 via I/O device interface 830. In some embodiments, the summary is the same as or generally similar to summary 406.

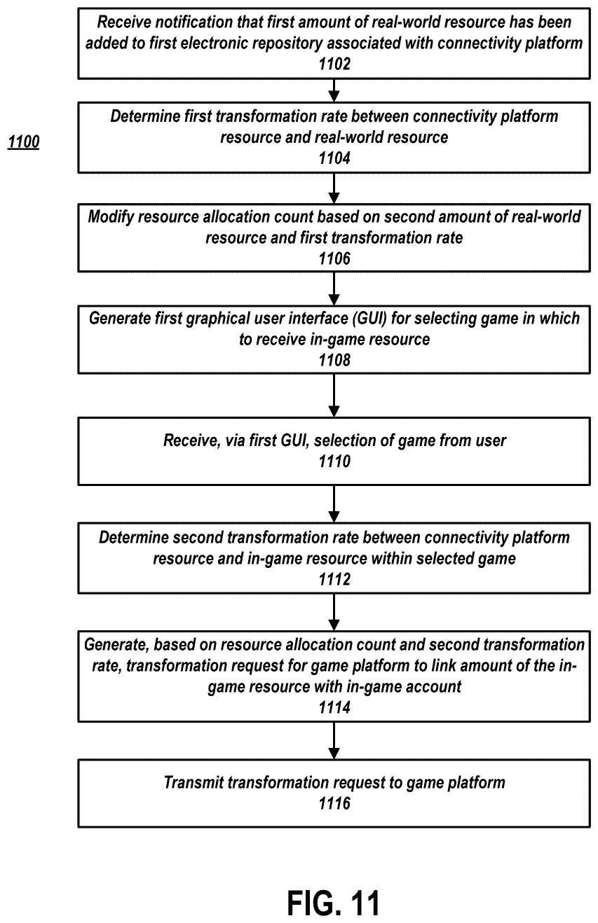

FIG. 11 is a flowchart of operations 1100 for obtaining in-game resources based on transformations of real-world resources into on-chain resources. The operations of FIG. 11 may use components described in relation to FIG. 8 and/or FIG. 9. In some embodiments, connectivity platform 102 may include one or more components of computer system 800. At 1102, connectivity platform 102 receives a notification that a first amount of a real-world resource has been added to a first electronic repository associated with connectivity platform 102. For example, connectivity platform 102 may receive, from transformation platform 108, one or more notifications (e.g., over network 150). Connectivity platform 102 may receive the one or more notifications using network interface 840 over network 150. In some embodiments, the one or more notifications may be the same as or generally similar to notification 502.

At 1104, connectivity platform 102 determines a first transformation rate between a connectivity platform resource and the real-world resource. For example, connectivity platform 102 may use one or more processors 810a, 810b, and/or 810n and/or network interface 840 to receive information regarding the respective values of the connectivity platform resource and the real-world resource and to calculate the first transformation rate based on that information. In some embodiments, the real-world resource may be the same as or generally similar to real-world resource 116, the connectivity platform resource may be the same as or generally similar to connectivity platform resource 508, and the first electronic repository may be the same as or generally similar to electronic repository 106.

At 1106, connectivity platform 102 modifies a resource allocation count associated with a user based on the second amount of the real-world resource and the first transformation rate. For example, connectivity platform 102 may use one or more processors 810a, 810b, and/or 810n to extract the second amount of the real-world resource and the first transformation rate from system memory 820 and store the modified resource allocation account in system memory 820. In some embodiments, the resource allocation count is increased based on the first amount of the real-world resource that was added to the first electronic repository and detected in 1104.

At 1108, connectivity platform 102 generates a first GUI for selecting a game in which to receive an in-game resource. Connectivity platform 102 may use one or more processors 810a, 810b, and/or 810n to generate the GUI, and the generation may include retrieving graphical elements stored in system memory 820. At 1110, connectivity platform 102 receives (e.g., over network 150), via the first GUI, a selection of a game from the user. Connectivity platform 102 may use one or more processors 810a, 810b, and/or 810n and/or network interface 840 to receive the selection. At 1112, connectivity platform 102 determines a second transformation rate between the connectivity platform resource and the in-game resource within the selected game. For example, connectivity platform 102 may use one or more processors 810a, 810b, and/or 810n and/or network interface 840 to receive information regarding the respective values of the connectivity platform resource and the in-game resource and to calculate the second transformation rate based on that information.

At 1114, connectivity platform 102 generates, based on the resource allocation count and the second transformation rate, a transformation request for a game platform to link an amount of the in-game resource with the in-game account. For example, connectivity platform 102 may use one or more processors 810a, 810b, and/or 810n to extract the resource allocation count and the second transformation rate from system memory 820 and/or generate the transformation request. At 1116, connectivity platform 102 transmits the transformation request to the game platform. For example, connectivity platform 102 may use one or more processors 810a, 810b, and/or 810n and/or network interface 840 to transmit the transformation request over network 150.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

I/We claim:

1. A system comprising:
at least one hardware processor; and
at least one non-transitory memory storing instructions, which, when executed by the at least one hardware processor, cause the system to:
receive, from a game platform at a connectivity platform, a request to transform one or more in-game resources into one or more on-chain resources, wherein the request comprises a game identifier associated with a game, an amount of an in-game resource to transform, and an in-game account associated with a user, wherein the game platform hosts gameplay services for the game, and wherein the user is logged in to the in-game account when the request is generated;
detect that a first amount of a real-world resource has been added to a first electronic repository associated with the connectivity platform;
increase a resource allocation count associated with the user based on the first amount of the real-world resource that was added to the first electronic repository;
determine a user account within the connectivity platform corresponding to the in-game account associated with the user, wherein determining the user account comprises searching an account database using the user account and identifying a link between the user account and the in-game account in the account database;
generate, based on the resource allocation count, a transformation request to transform a second amount of the real-world resource from the first electronic repository into a corresponding set of on-chain resources, wherein the transformation request comprises the second amount of the real-world resource, a transformation platform identifier associated with the user, and an indication of a type of the on-chain resources;
transmit the transformation request to a transformation platform;
receive a notification from the transformation platform that the transformation request has been executed; and
cause display of a graphical user interface indicating the second amount of the real-world resource, an acquired set of on-chain resources associated with the transformation request, and a summary of on-chain resources associated with the user.

2. The system of claim 1, further comprising instructions to:
cause display of a graphical user interface (GUI) for linking one or more in-game accounts with the user account, wherein the one or more in-game accounts includes the in-game account associated with the user;
receive, from the user via the GUI, a selection of the game identifier associated with the game;
generate for display a prompt for the user to input a credential for the in-game account, wherein the credential is used by the game platform to verify that the in-game account is associated with the user;
transmit the credential to the game platform;
receive a verification from the game platform that the in-game account is associated with the user; and
based on the verification, link the user account with the in-game account in the account database.

3. The system of claim 1, wherein detecting that the first amount of the real-world resource has been added to the first electronic repository further comprises:
monitoring the first electronic repository for changes in real-world resources within the first electronic repository; and
detecting a change in real-world resources associated with the request to convert one or more in-game resources into one or more on-chain resources, wherein detecting the change comprises identifying that the change is associated with the first amount of the real-world resource and the in-game account.

4. The system of claim 1, wherein detecting that the first amount of the real-world resource has been added to the first electronic repository further comprises receiving a notification from the first electronic repository that a change in real-world resources within the first electronic repository has been made, wherein the notification includes an indication that the change is associated with the amount of the real-world resource and the in-game account.

5. The system of claim 1, further comprising instructions to:
generate a transfer request to transfer a third amount of the real-world resource from the first electronic repository to a second electronic repository associated with the game platform;
transmit the transfer request to the first electronic repository; and
decrease the resource allocation count based on the third amount of the real-world resource.

6. A method, comprising:
receiving, from a game platform at a connectivity platform, a request to transform one or more in-game resources into one or more on-chain resources, wherein the request comprises a game identifier associated with a game, an amount of an in-game resource to transform, and an in-game account associated with a user, wherein the game platform hosts gameplay services for the game, and wherein the user is logged in to the in-game account when the request is generated;
detecting that a first amount of a real-world resource has been added to a first electronic repository associated with the connectivity platform;
increasing a resource allocation count associated with the user based on the first amount of the real-world resource that was added to the first electronic repository;
determining a user account within the connectivity platform corresponding to the in-game account associated with the user;
generating, based on the resource allocation count, a transformation request to transform a second amount of the real-world resource from the first electronic repository into a corresponding set of on-chain resources, wherein the transformation request comprises the second amount of the real-world resource, a transformation platform identifier associated with the user, and an indication of a type of the on-chain resources; and
transmitting the transformation request to a transformation platform.

7. The method of claim 6, further comprising:
causing display of a graphical user interface (GUI) for linking one or more in-game accounts with the user account, wherein the one or more in-game accounts includes the in-game account associated with the user;
receiving, from the user via the GUI, a selection of the game identifier associated with the game;
generating for display a prompt for the user to input a credential for the in-game account, wherein the credential is used by the game platform to verify that the in-game account is associated with the user;
transmitting the credential to the game platform;
receiving a verification from the game platform that the in-game account is associated with the user; and
based on the verification, linking the user account with the in-game account in an account database.

8. The method of claim 6, wherein determining the user account on the connectivity platform associated with the in-game account further comprises:
searching an account database using the user account; and
identifying a link between the user account and the in-game account in the account database.

9. The method of claim 6, wherein detecting that the first amount of the real-world resource has been added to the first electronic repository further comprises:
monitoring the first electronic repository for changes in real-world resources within the first electronic repository; and
detecting a change in real-world resources associated with the request to convert one or more in-game resources into one or more on-chain resources, wherein detecting the change comprises identifying that the change is associated with the first amount of the real-world resource and the in-game account.

10. The method of claim 6, wherein detecting that the first amount of the real-world resource has been added to the first electronic repository further comprises receiving a notification from the first electronic repository that a change in real-world resources within the first electronic repository has been made, wherein the notification includes an indication that the change is associated with the amount of the real-world resource and the in-game account.

11. The method of claim 6, wherein generating the transformation request further comprises receiving an indication from the user of the second amount of the real-world resource to transform.

12. The method of claim 6, wherein generating the transformation request further comprises:
causing display of a graphical user interface that includes a list of amounts of the real-world resource, wherein the list includes, for each request, a corresponding entry indicating (1) the first amount of the real-world resource, (2) a corresponding in-game resource amount, and (3) a corresponding game identifier, and wherein each entry in the list is associated with the user;
receiving a selection from the user of at least one of the amounts of the real-world resource in the list; and
basing the second amount of the real-world resource on a total of the amounts selected by the user from the list.

13. The method of claim 6, further comprising:
receiving a notification from the transformation platform that the transformation request has been executed; and
causing display of a graphical user interface indicating the second amount of the real-world resource, an acquired set of on-chain resources associated with the transformation request, and a summary of on-chain resources associated with the user.

14. The method of claim 6, further comprising:
generating a transfer request to transfer a third amount of the real-world resource from the first electronic repository to a second electronic repository associated with the game platform;
transmitting the transfer request to the first electronic repository; and
decreasing the resource allocation count based on the third amount of the real-world resource.

15. A non-transitory, computer-readable storage medium comprising instructions recorded thereon, wherein the instructions, when executed by at least one data processor of a system, cause the system to:
receive, from a game platform at a connectivity platform, a request to transform one or more in-game resources into one or more on-chain resources, wherein the request comprises a game identifier associated with a game, an amount of an in-game resource to transform, and an in-game account associated with a user, wherein the game platform hosts gameplay services for the game, and wherein the user is logged in to the in-game account when the request is generated;
detect that a first amount of a real-world resource has been added to an electronic repository associated with the connectivity platform;
increase a resource allocation count associated with the user based on the first amount of the real-world resource that was added to the electronic repository;
determine a user account within the connectivity platform corresponding to the in-game account associated with the user, wherein determining the user account comprises searching an account database using the user account and identifying a link between the user account and the in-game account in the account database;
generate, based on the resource allocation count, a transformation request to transform a second amount of the real-world resource from the electronic repository into a corresponding set of on-chain resources, wherein the transformation request comprises the second amount of the real-world resource, a transformation platform identifier associated with the user, and an indication of a type of the on-chain resources;
transmit the transformation request to a transformation platform;
receive a notification from the transformation platform that the transformation request has been executed; and
cause display of a graphical user interface indicating the second amount of the real-world resource, an acquired set of on-chain resources associated with the transformation request, and a summary of on-chain resources associated with the user.

16. The non-transitory, computer-readable storage medium of claim 15, wherein the instructions further cause the system to:
cause display of a graphical user interface (GUI) for linking one or more in-game accounts with the user account, wherein the one or more in-game accounts includes the in-game account associated with the user;
receive, from the user via the GUI, a selection of the game identifier associated with the game;
generate for display a prompt for the user to input a credential for the in-game account, wherein the credential is used by the game platform to verify that the in-game account is associated with the user;
transmit the credential to the game platform;
receive a verification from the game platform that the in-game account is associated with the user; and
based on the verification, link the user account with the in-game account in the account database.

17. The non-transitory, computer-readable storage medium of claim 15, wherein detecting that the first amount of the real-world resource has been added to the electronic repository further comprises:
monitoring the electronic repository for changes in real-world resources within the electronic repository; and
detecting a change in real-world resources associated with the request to convert one or more in-game resources into one or more on-chain resources, wherein detecting the change comprises identifying that the change is associated with the first amount of the real-world resource and the in-game account.

18. The non-transitory, computer-readable storage medium of claim 15, wherein detecting that the first amount of the real-world resource has been added to the electronic repository further comprises receiving a notification from the electronic repository that a change in real-world resources within the electronic repository has been made, wherein the notification includes an indication that the change is associated with the amount of the real-world resource and the in-game account.

19. The non-transitory, computer-readable storage medium of claim 15, wherein generating the transformation request further comprises receiving an indication from the user of the second amount of the real-world resource to transform.

20. The non-transitory, computer-readable storage medium of claim 15, wherein generating the transformation request further comprises:
causing display of a graphical user interface that includes a list of amounts of the real-world resource, wherein the list includes, for each request, a corresponding entry indicating (1) the first amount of the real-world resource, (2) a corresponding in-game resource amount, and (3) a corresponding game identifier, and wherein each entry in the list is associated with the user;
receiving a selection from the user of at least one of the amounts of the real-world resource in the list; and
basing the second amount of the real-world resource on a total of the amounts selected by the user from the list.
